(19) United States
(12) Patent Application Publication
(10) Pub. No.: US 2011/0051745 A1
(43) Pub. Date: Mar. 3, 2011

(54) METHOD OF ENCAPSULATING DATA IN DIGITAL SATELLITE COMMUNICATION SYSTEM, AND DATA TRANSMISSION APPARATUS THEREFOR

(75) Inventors: Nam-kyung Lee, Daejeon-si (KR); Dae-ig Chang, Daejeon-si (KR); Ho-jin Lee, Daejeon-si (KR)

(73) Assignee: ELECTRONICS AND TELECOMMUNICATIONS RESEARCH INSTITUTE, Daejeon-si (KR)

(21) Appl. No.: 12/812,987

(22) PCT Filed: Aug. 27, 2009
(86) PCT No.: PCT/KR2009/004796

§ 371 Date: Jul. 15, 2010

(30) Foreign Application Priority Data
Sep. 23, 2008 (KR) 10-2008-0093233

(51) Int. Cl. H04J 3/24

(52) U.S. Cl. 370/474

(57) ABSTRACT

Provided is a satellite network communication system based on Second Generation Digital Video Broad-casting via Satellite (DVB-S2). A method for encapsulating transmission data in a digital satellite communication system includes: determining whether a time at which a reference time information packet has to be inserted into a packet data unit is arrived, in the digital satellite communication system; and if the time at which the reference time information packet has to be inserted into the packet data unit is arrived, transforming the packet data unit in the form of a baseband data packet including the reference time information packet. Therefore, by allowing transmission of Network Clock Reference (NCR) information in a satellite communication environment based on Generic Steam Encapsulation (GSE), bidirectional satellite communications are possible.

### TECHNICAL FIELD

The present invention relates to a satellite communication system based on Second Generation Digital Video Broadcasting via Satellite (DVB-S2), and more particularly, to a technology for encapsulating transmission data.

### BACKGROUND ART

Systems for high-speed bidirectional satellite communications through a satellite network use a Digital Video Broadcasting-Satellite (DVB-S) based on Time Division Multiplexer (TDM) in a forward line, and use a Digital Video Broadcasting with Return Channel via Satellite (DVB-RCS) based on Time Division Multiple Access (TDMA) in a backward link. Such a satellite broadcasting and communication system adds Program Clock Reference (PCR) information of a reference clock signal generated by a Hub station to a Moving Picture Experts Group2-Transport Stream (MPEG2-TS) packet with a specific program ID (PID), and periodically transmits the resultant packet to a receiving party, thereby restoring a clock signal of the receiving party.

The receiving party restores the reference clock signal of the Hub station using the PCR information itself and a transmission period (called a PCR period) of the PCR information, and uses the restored reference clock signal as its own reference clock signal. Such PCR information, which is added to a MPEG-based PCR field to restore the clock signal in the backward link and maintain timing synchronization via a satellite, is called Network Clock Reference (NCR).

An existing digital video broadcasting (DVB) standard is based on Moving Picture Experts Group-Transport Stream (MPEG-TS) transmission, whereas a next-generation standard such as DVB-S2 supports variable-length packet transmission called Generic Steam Encapsulation (GSE).

However, since the GSE does not consider transmission of NCR from a Hub station to terminals, bidirectional satellite communications are impossible under the present circumferences.

### DISCLOSURE OF INVENTION

### Technical Problem

The following description relates to a data encapsulation method and a data transmission apparatus that allow bidirectional communications through a satellite communication network.

### Technical Solution

According to an exemplary aspect, there is provided an encapsulation method by which a Hub station transforms a packet data unit to be transmitted in a form of a baseband data packet, in a digital satellite communication system, the encapsulation method including: determining whether a time at which a reference time information packet has to be inserted into the packet data unit is arrived, in the digital satellite communication system; and if the time at which the reference time information packet has to be inserted into the packet data unit is arrived, transforming the packet data unit in the form of a baseband data packet including the reference time information packet.

The transforming of the packet data unit includes: determining whether or not information for a modulation/demodulation method of the packet data unit is the same as information for a modulation/demodulation method of the reference time information packet, on the basis of an information table including information for encapsulation; and if the information for the modulation/demodulation method of the packet data unit to be transmitted is the same as the information for the modulation/demodulation method of the reference time information packet, forming the baseband data packet such that the packet data unit and the reference time information packet are included in a baseband frame field of the baseband data packet.

The forming of the baseband data packet includes if the information for the modulation/demodulation method of the packet data unit is different from the information for the modulation/demodulation method of the reference time information packet, inserting the reference time information packet into a separate baseband data packet based on the modulation/demodulation method of the reference time information packet.

According to another exemplary aspect, there is provided a data transmission apparatus included in a Hub station of a digital satellite communication system, including: an encapsulator performing encapsulation by dividing a packet data unit that is to be transmitted into a plurality of variable length packets and adding headers respectively to each variable length packet and a reference time information packet; and a packet former forming a baseband data packet by scheduling the encapsulated variable length packet and the encapsulated reference time information packet.

The packet former determines whether or not information for a modulation/de-modulation method of the packet data unit is the same as information for a modulation/demodulation method of the reference time information packet, on the basis of the information table including the information for encapsulation, and forms the baseband data packet such that the packet data unit and the reference time information packet are included in a baseband frame field of the baseband data packet, if the information for the modulation/demodulation method of the packet data unit is the same as the information for the modulation/demodulation method of the reference time information packet, and if the information for the modulation/demodulation method of the packet data unit is different from the information for the modulation/demodulation method of the reference time information packet, inserts the reference time information packet into a separate baseband data packet based on the modulation/demodulation method of the reference time information packet.

Additional features of the invention will be set forth in the description which follows, and in part will be apparent from the description, or may be learned by practice of the invention.

### ADVANTAGEOUS EFFECTS

According to the exemplary aspects, by allowing transmission of Network Clock Reference (NCR) information in a satellite communications environment based on Generic Stream Encapsulation (GSE), bidirectional satellite communications are possible.

Bidirectional satellite communications reduce overhead of about 10% occurring when a MPE/MPEG-TS method is applied to an existing DVB-S or DVB-S2 system to about 2-3%, which leads to a 5-10% increase in throughput.

### BRIEF DESCRIPTION OF DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram of an apparatus for transmitting data through a satellite communications network, according to an exemplary embodiment.

FIG. 2 shows an exemplary information table including information for encapsulation according to an exemplary embodiment.

FIG. 3 shows a configuration of a Generic Steam Encapsulation (GSE) packet including a reference time information packet, according to an exemplary embodiment.

FIG. 4 shows a configuration of a baseband data packet including a reference time information packet, according to an exemplary embodiment.

FIG. 5 is a view for explaining packet configurations to which no reference time information is reflected, according to an exemplary embodiment.

FIGS. 6 and 7 are views for explaining packet configurations to which reference time information is reflected, according to exemplary embodiments.

FIG. 8 is a flowchart of a method for encapsulating transmission data in a digital satellite communications system, according to an exemplary embodiment.

### MODE FOR THE INVENTION

The invention is described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

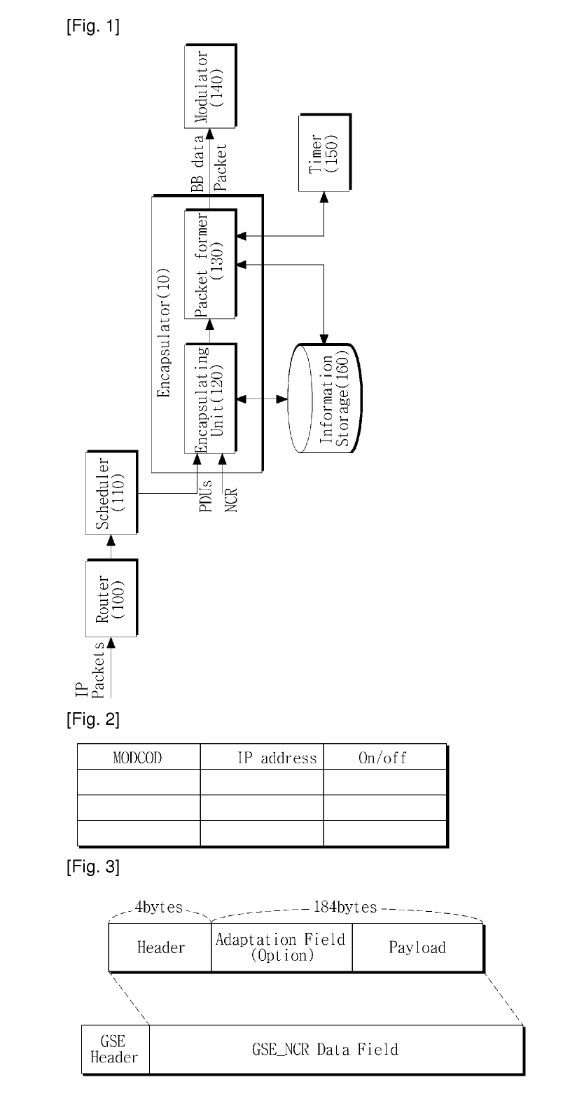

FIG. 1 is a block diagram of an apparatus for transmitting data through a satellite communication network, according to an exemplary embodiment.

Referring to FIG. 1, the data transmission apparatus includes a router 100, a scheduler 110, an encapsulator 120 including an encapsulating unit 120 and a packet former 130, and a modulator 140.

The router 100 routes Internet Protocol (IP) packets or other network layer packets respectively to the corresponding buffers according to their destination addresses and QoS requirements/priority information.

The scheduler 110 selects packets that are to be transmitted from among the routed packets based on a specific scheduling policy, schedules the selected packets, and then outputs them in the form of Packet Data Units (PDUs). Here, the PDUs may be IP datagrams, Ethernet frames, or other network layer packets.

In the current embodiment, the encapsulator 10 is a Generic Stream Encapsulation

(GSE) encapsulator. The encapsulator 10 encapsulates the PDUs and outputs the results of the encapsulation in the form of baseband data packets (denoted as BB data packets in FIG. 1).

According to an exemplary embodiment, the encapsulating unit 120 encapsulates the PDUs and a reference time information packet into at least one GSE packet.

In detail, the encapsulating unit 120 recognizes length information of a baseband data packet from packet configuration information stored in an information storage 160, fragments the PDUs according to the length information of the baseband data packet and then encapsulates the fragmented PDUs into at least one GSE packet.

According to an exemplary embodiment, a DVB-S2 system may use both Constant Coding and Modulation (CCM) and Adaptive Coding and Modulation (ACM) tech-nologies.

The CCM technology uses a fixed modulation method and a channel coding method, and in the ACM technology, a transmitting party changes an encryption/modulation method adaptively according to the data reception performance of a receiving party and transmits MODCOD (Modulation & Coding) information for the encryption/modulation method together with data to the receiving party, and the receiving party changes a decryption/demodulation method of received signals according to the MODCOD information.

The information storage 160 may be a memory and stores information for packet configuration. That is, the information for packet configuration includes MODCOD information. FIG. 2 shows an exemplary information table including information for encapsulation. As shown in FIG. 2, the information storage 160 stores MODCOD information including modulation/demodulation format information and code rate information, address information of physical interfaces using the MODCOD information, and information indicating whether or not the physical interfaces are used.

Upon encapsulation, the encapsulating unit 120 adds a GSE header to each PDU based on the MODCOD information, and adds packet data or a reference time information packet to a payload of the PDU with the GSE header, thus generating a GSE packet. The GSE format is different from the MPEG format defined in the existing ISO/IEC 13818-1 standard, and may effectively encapsulate network layer packets, such as IP packets, MPEG packets, ATM packets, Ithernet packets, IEEE 802.1x packets and the like.

The reference time information packet may include Network Clock Reference (NCR) information. In this case, the encapsulating unit 120 may encapsulate the reference time information packet into a single GSE packet, not fragmenting the reference time information packet into a plurality of GSE packets.

Then, the packet former 130 forms a baseband data packet including GSE packets encapsulated by the encapsulating unit 120. The packet former 130 generates a baseband data packet including at least one GSE packet with a reference time information packet periodically according to a count value of a timer 150. If a time at which reference time information has to be inserted is arrived when no packet data unit (PDU) is received, the packet former 130 sets NCR_MODCOD information having the lowest efficiency to reference time information based on information stored in the information storage 160, and generates a baseband data packet including a GSE packet with the reference time information.

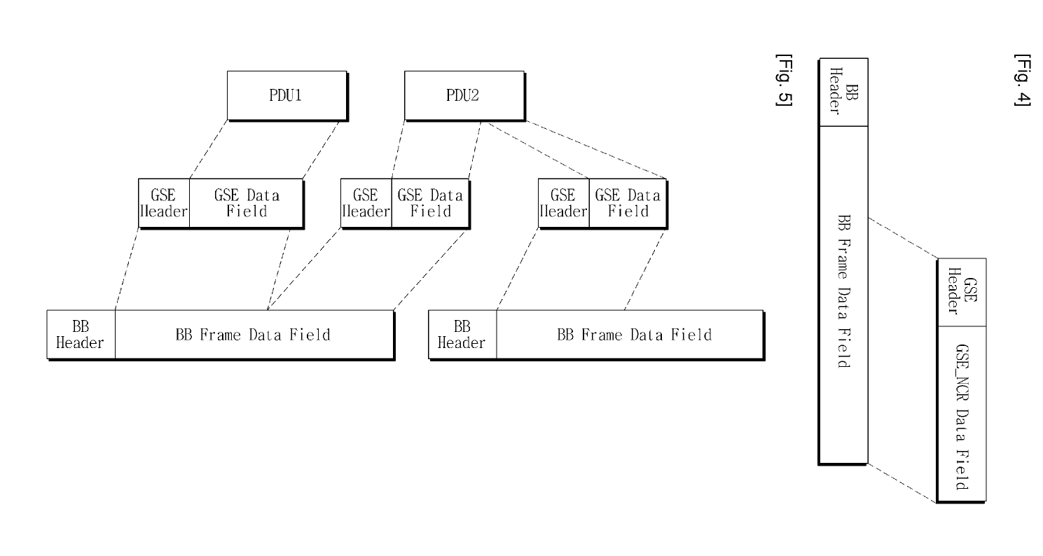

FIG. 3 shows a configuration of a GSE packet (that is, a GSE_NCR packet) including a reference time information packet, according to an exemplary embodiment. In FIG. 3, reference time information is contained in the payload of the GSE_NCR packet. However, the configuration of a GSE_NCR packet is not limited to the current embodiment illustrated in FIG. 3, and may depend on the configuration of the reference time information packet.

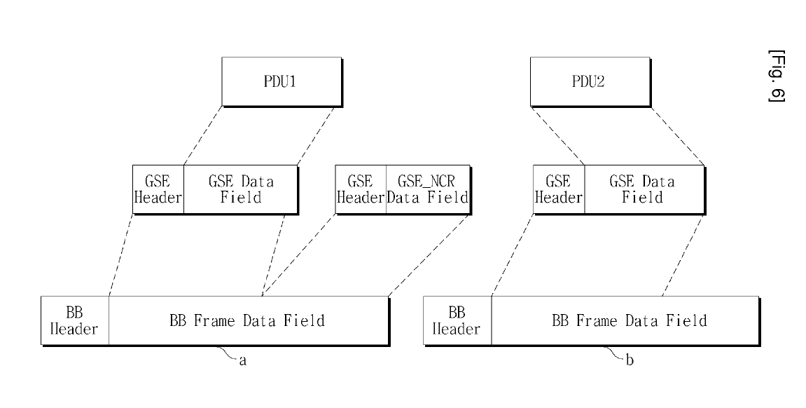

FIG. 4 shows a configuration of a baseband data packet including a reference time information packet, according to an exemplary embodiment. In the current embodiment illustrated in FIG. 4, a GSE packet including a GSE_NCR packet is located at the lower portion of a frame data field of the baseband data packet.

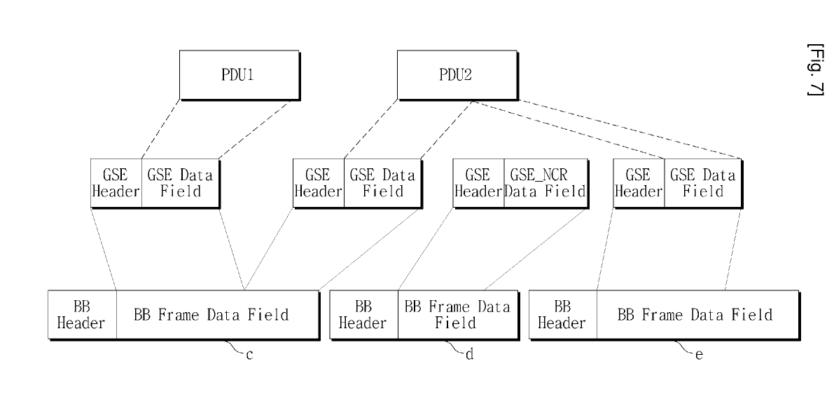

FIGS. 5, 6 and 7 are views for explaining packet configurations when encapsulation is performed, according to exemplary embodiments.

FIG. 5 is a view for explaining a packet configuration to which no reference time information is reflected, according to an exemplary embodiment. As illustrated in FIG. 5, GSE headers are added to input PDUs (that is, PDU1 and PDU2). In detail, the length of a data field of a baseband data packet is recognized from information stored in the information storage 160 (see FIG. 1), the PDU1 and PDU2 are fragmented based on the length of the data field of the baseband data packet, and then GSE headers are added respectively to the fragmented PDUs. Referring to FIG. 1, the encapsulating unit 120 encapsulates the PDUs into GSE packets.

Then, the encapsulated GSE packets are sequentially inserted into baseband frame data fields.

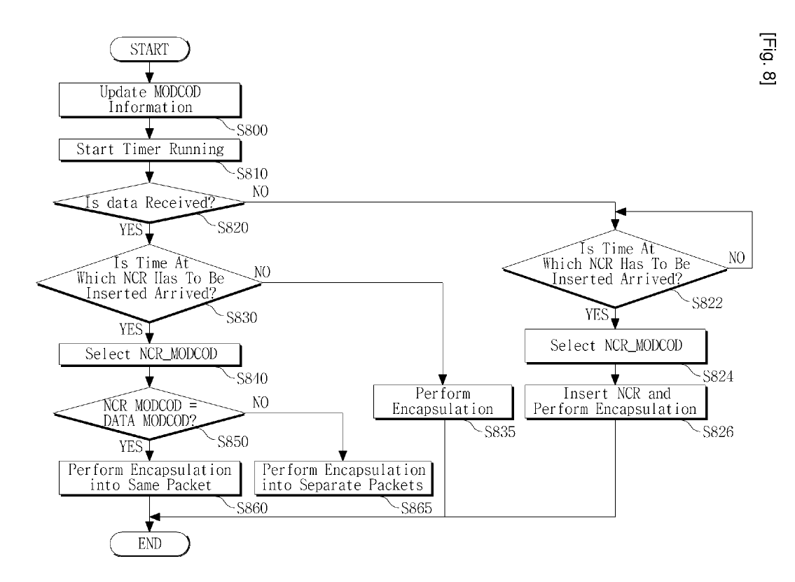

FIGS. 6 and 7 are views for explaining packet configurations to which reference time information is reflected, according to exemplary embodiments. FIG. 6 shows a packet configuration when MODCOD information (Data_MODCOD) of a PDU (that is, packet data that is to be transmitted) is the same as MODCOD information (NCR_MODCOD) of a reference time information packet. That is, in this case, MODCOD information of a baseband data packet a is the same as the Data_MODCOD and NCR_MODCOD.

Meanwhile, FIG. 7 shows a packet configuration when MODCOD information (Data_MODCOD) of packet data that is to be transmitted is different from MODCOD information (NCR_MODCOD) of a reference time information packet. As illustrated in FIG. 7, in this case, a GSE packet including a reference time information packet (that is, GSE_NCR Data Field) is inserted into a separate baseband data field including NCR_MODCOD information. In detail, in the current embodiment illustrated in FIG. 7, MODCOD information of a baseband frame data field c and MODCOD information of a baseband frame data field e are the same as the Data-_MODCOD, whereas MODCOD information of a baseband frame data field d is the same as the NCR_MODCOD.

FIG. 8 is a flowchart of a method for encapsulating transmission data in a digital satellite communication system, according to an exemplary embodiment.

Referring to FIG. 8, first, an information table including information for encapsulation is updated when a system is initialized (operation S800). Information for packet configuration includes MODCOD information. That is, the information table with the information for encapsulation includes MODCOD information including modulation/demodulation format information and code rate information, address information of physical interfaces using the MODECOD information, and information indicating whether or not the physical interfaces are used.

Then, a timer begins to run in order to transmit reference time information, that is, NCR information (operation S810).

If packet data that is to be transmitted is received (operation S820), it is determined whether a time at which NCR information has to be inserted into the packet data is arrived. If a time at which NCR information has to be inserted into the packet data is arrived, NCR_MODCOD information of a reference time information packet is selected from the information table including information for encapsulation (operation S840).

Successively, it is determined whether information (that is, Data_MODCOD) for a modulation/demodulation format of the packet data is the same as information (that is, NCR_MODCOD) for a modulation/demodulation format of the reference time information packet (operation S850).

If the Data_MODCOD is the same as the NCR_MODCOD, a baseband data packet including PDUs (that is, the packet data) and the reference time information packet in its baseband frame field is generated (operation S860).

Meanwhile, if the Data_MODCOD is different from the NCR_MODCOD, encapsulation of the NCR_MODCOD into a separate baseband data packet is performed (operation S865).

If a time at which a reference time information packet has to be inserted into the data packet is not arrived, the data packet is encapsulated (operation S835). In the current embodiment, the encapsulation may be performed based on a GSE protocol.

Meanwhile, if a time at which a reference time information packet (that is, NCR_MODCOD) has to be inserted is arrived when no packet data that is to be transmitted is received, NCR_MODCOD for a reference time information packet is selected from the information table (operation S824). At this time, NCR_MODCOD having the lowest efficiency may be selected from the information table. Then, a GSE header is added to the NCR_MODCOD to generate a GSE packet, and a baseband data packet including the GSE packet is generated (operation S826).

Meanwhile, the encapsulation method as described above can be written as a computer program. Also, the computer program can be stored in a computer readable recording media, and read and executed by a computer. The computer readable recording media includes a magnetic recording media, an optical recording media, etc.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

### INDUSTRIAL APPLICABILITY

The present invention can be efficiently applied to various high-speed bidirectional communications such as satellite communications.

1. An encapsulation method by which a Hub station transforms a packet data unit to be transmitted in a form of a baseband data packet, in a digital satellite communication system, the encapsulation method comprising:
determining whether a time at which a reference time information packet has to be inserted into the packet data unit is arrived, in the digital satellite communication system; and
if the time at which the reference time information packet has to be inserted into the packet data unit is arrived, transforming the packet data unit in the form of a baseband data packet including the reference time information packet.

2. The encapsulation method of claim 1, wherein the transforming of the packet data unit comprises:
determining whether or not information for a modulation/demodulation method of the packet data unit is the same as information for a modulation/demodulation method of the reference time information packet, on the basis of an information table including information for encapsulation; and
if the information for the modulation/demodulation method of the packet data unit is the same as the information for the modulation/demodulation method of the reference time information packet, forming the baseband data packet such that the packet data unit and the reference time information packet are included in a baseband frame field of the baseband data packet.

3. The encapsulation method of claim 2, wherein the forming of the baseband data packet comprises if the information for the modulation/demodulation method of the packet data unit is different from the information for the modulation/demodulation method of the reference time information packet, inserting the reference time information packet into a separate baseband data packet based on the modulation/demodulation method of the reference time information packet.

4. The encapsulation method of claim 2, wherein the forming of the baseband data packet comprises locating the reference time information packet after the packet data unit in the same baseband frame field.

5. The encapsulation method of claim 2, wherein the information table including the information for encapsulation includes modulation/demodulation format information, code rate information, address information of physical interfaces, and information indicating whether or not the physical interfaces are used.

6. The encapsulation method of claim 1, wherein the forming of the baseband data packet comprises, if no packet data unit that is to be transmitted is received, inserting the reference time information packet into a baseband data packet having lowest efficiency for a modulation/demodulation method which is determined on the basis of an information table including information for encapsulation.

7. The encapsulation method of claim 2, further comprising updating the information table including the information for encapsulation when the Hub station is initialized.

8. A data transmission apparatus included in a Hub station of a digital satellite communication system, comprising:
an encapsulator performing encapsulation by dividing a packet data unit that is to be transmitted into a plurality of variable-length packets and adding headers respectively to each variable length packet and a reference time information packet; and
a packet former forming a baseband data packet by scheduling the encapsulated variable-length packets and the encapsulated reference time information packet.

9. The data transmission apparatus of claim 8, further comprising a timer for counting a time period, wherein the packet former inserts the reference time information packet into the baseband data packet periodically according to a count value of the timer.

10. The data transmission apparatus of claim 8, wherein the encapsulator recognizes length information of the baseband data packet from an information table including information for encapsulation.

11. The data transmission apparatus of claim 10, wherein the packet former determines whether or not information for a modulation/demodulation method of the packet data unit is the same as information for a modulation/demodulation method of the reference time information packet, on the basis of the information table including the information for encapsulation, and forms the baseband data packet such that the packet data unit and the reference time information packet are included in a baseband frame field of the baseband data packet, if the information for the modulation/demodulation method of the packet data unit is the same as the information for the modulation/demodulation method of the reference time information packet.

12. The data transmission apparatus of claim 11, wherein the packet former locates the reference time information packet after the packet data unit in the baseband frame field of the baseband data packet.

13. The data transmission apparatus of claim 10, wherein if the information for the modulation/demodulation method of the packet data unit is different from the information for the modulation/demodulation method of the reference time information packet, the packet former inserts the reference time information packet into a separate baseband data packet based on the modulation/demodulation method of the reference time information packet.

14. The data transmission apparatus of claim 10, wherein if a time at which the reference time information packet has to be inserted is arrived when no packet data unit is received, the packet former inserts the reference time information packet into a baseband data packet having lowest efficiency for a modulation/demodulation method which is determined on the basis of the information table including the information for encapsulation.

15. The data transmission apparatus of claim 10, wherein the information table including the information for encapsulation includes modulation/demodulation format information, code rate information, address information of physical interfaces, and information indicating whether or not the physical interfaces are used.
